(19) United States
(12) Patent Application Publication
(10) Pub. No.: US 2012/0051180 A1
(43) Pub. Date: Mar. 1, 2012

(54) METHOD AND APPARATUS FOR FREQUENCY DOMAIN REVERSE-TIME MIGRATION WITH SOURCE ESTIMATION

(75) Inventor: Changsoo Shin, Seoul (KR)

(73) Assignee: SNU R&DB FOUNDATION, Seoul (KR)

(21) Appl. No.: 13/165,185

(22) Filed: Jun. 21, 2011

(30) Foreign Application Priority Data
Aug. 24, 2010 (KR) 10-2010-0082161

(51) Int. Cl. G01V 1/28

(52) U.S. Cl. 367/50

(57) ABSTRACT

Provided is seismic imaging, particularly, reverse-time migration for generating a real subsurface image from modeling parameters calculated by waveform inversion, etc. A frequency-domain reverse-time migration apparatus includes: a source estimator configured to estimate sources from data measured on a plurality of receivers; and a migration unit configured to receive information about the sources estimated by the source estimator and to perform reverse-time migration in the frequency domain. The source estimator estimates the sources by updating an initial source vector using incremental changes according to a full Newton method. In more detail, the migration unit includes: a back-propagation unit configured to back-propagate the measured data; a virtual source estimator configured to estimate virtual sources from the sources estimated by the source estimator; and a convolution unit configured to convolve the back-propagated measured data with the virtual sources and to output the results of the convolution.

### CROSS-REFERENCE TO RELATED APPLICATION

This application claims the benefit under 35 U.S.C. §119(a) of a Korean Patent Application No. 10-2010-0082161, filed on Aug. 24, 2010, the entire disclosure of which is incorporated herein by reference for all purposes.

### BACKGROUND

1. Field

The following description relates to seismic imaging, and more particularly, to reverse-time migration for generating a real subsurface image from modeling parameters calculated by waveform inversion, etc.

2. Description of the Related Art

A two-way migration method requires significantly more computational resources than a one-way migration method. However, since the two-way migration method has substantially no dip limitation as well as processing multiarrivals, the two-way migration method allows seismic imaging regardless of the inclination of a reflection surface and also can preserve the real amplitudes of seismic wavefields. For these reasons, the two-way migration method has been widely utilized with the rapid growth of computing technology.

Inverse-time migration is performed by back-propagating field data, that is, measured data. Tarantola showed that reverse-time migration is tantamount to performing the first iteration of full waveform inversion (Tarantola, A., 1984, Inversion of Seismic Reflection Data in the Acoustic Approximation: Geophysics, 49, 1259-1266). Accordingly, as disclosed in papers “An Optimal True-amplitude Least-squares Prestack Depth-migration Operator: Geophysics, 64(2), 508-515” (Chavent, G., and R.-E. Plessix, 1999) and “Evaluation of Poststack Migration in Terms of Virtual Source and Partial Derivative Wavefields: Journal of Seismic Exploration, 12, 17-37” (Shin, C., D.-J.Min, D. Yang and S.-K.Lee, 2003), reverse-time migration shares the same algorithm as waveform inversion. Waveform inversion is accomplished by back-propagating the residuals between measured field data and initial model responses, whereas reverse-time migration back-propagates measured field data.

Various sources were used in seismic exploration, but it was not easy to accurately detect the waveforms of the sources since there are non-linear wave propagation and noise near the sources, coupling between the sources and receives, etc. Existing reverse-time migration has been performed under an assumption that a source such as a Ricker wavelet is a true source. Accordingly, the existing reverse-time migration failed to reflect accurate sources, which became a factor limiting the resolution of reverse-time migration.

### SUMMARY

The following description relates to a technique for improving the resolution of reverse-time migration through source estimation.

In one general aspect, there is provided a frequency-domain reverse-time migration apparatus including: a source estimator configured to estimate sources from data measured on a plurality of receivers; and a migration unit configured to receive information about the sources estimated by the source estimator and to perform reverse-time migration in the frequency domain.

The source estimator estimates the sources using a least-squares method in the frequency domain, and in more detail, the source estimator estimates the sources by updating an initial source vector using incremental changes according to a full Newton method.

The migration unit includes: a back-propagation unit configured to back-propagate the measured data; a virtual source estimator configured to estimate virtual sources from the sources estimated by the source estimator; and a convolution unit configured to convolve the back-propagated measured data with the virtual sources and to output the results of the convolution.

The frequency-domain reverse-time migration apparatus further includes a scaling unit configured to scale the migrated image output from the migration unit using diagonal terms of a pseudo-Hessian matrix.

The frequency-domain reverse-time migration apparatus further includes a geometric-spreading compensation unit configured to multiply the image scaled by the scaling unit by a depth-variant scaling function.

The frequency-domain reverse-time migration apparatus further includes an amplitude amplifying unit configured to multiply a migrated image for each frequency output from the migration unit by an amplitude spectrum of a source estimated by the source estimator.

The reverse-time migration method is applied to a synthetic simple syncline model having the distance of 3 km and the depth of 1.5 km, whose grid interval is 7.5 m. The number of shots and receivers are 80 and 200, respectively, and the receiver interval is the same as the grid interval. The total recording length is 2.5 seconds, and a frequency band ranging from 0.4 to 50 Hz is used for reverse-time migration.

FIGS. 3 and 4 are graphs plotting the amplitudes and phases of the estimated source wavelet and the true source wavelet applied to the synthetic simple syncline model.

FIGS. 3 and 4 respectively show the amplitudes and phases of the estimated and true source wavelets. It can be seen from FIGS. 3 and 4 that the estimated source wavelet is nearly identical to the true source wavelet. When the results of reverse-time migration based on the estimated source wavelet are compared with the results of reverse-time migration under the assumption that a source is a Ricker wavelet as in a conventional technique, boundaries of layers are more clearly shown in the results of reverse-time migration based on the estimated source wavelet.

Next, the fidelity of the reverse-time migration for IFP original Marmousi data disclosed in the paper “Marmousi, model and data, in Versteeg, R., and Grau, G., Eds., The Marmousi experience, Proceedings of the 1990 EAEG workshop on Practical Aspects of Seismic Data Inversion: EAEG, 5-16” (Bourgeois, A., Bourget, M., Lailly, P., Poulet, M., Ricarte, P., and Versteeg, R., 1991) has been investigated. In this model, frequencies ranging from 0.34578 to 60 Hz were used in intervals of 0.34578 Hz, the total recording time was 3 seconds, and the sampling interval was 0.004 seconds. The grid interval was 16 m, and the number of shots was 240. FIG. 5 is a graph plotting the relative signal amplitudes of the estimated source wavelet for an IFP original Marmousi data and the true source wavelet. It is seen from FIG. 5 that the estimated source wavelet nearly approximates the true source wavelet. FIG. 5 describes that the boundaries of the layers are more clearly located, which demonstrates that source wavelet estimation enhances the resolution of migration images.

Other features and aspects will be apparent from the following detailed description, the drawings, and the claims.

### BRIEF DESCRIPTION OF THE DRAWINGS

FIG. 1 is a diagram illustrating an example of a reverse-time migration apparatus.

FIG. 2 is a flowchart illustrating an example of a reverse-time migration method. FIGS. 3 and 4 are graphs plotting the amplitudes and phases of an estimated source wavelet and a true source wavelet applied to a synthetic simple syncline model.

FIG. 5 is a graph plotting the relative signal amplitudes of an estimated source wavelet for an IFP original Marmousi data and the true source wavelet.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

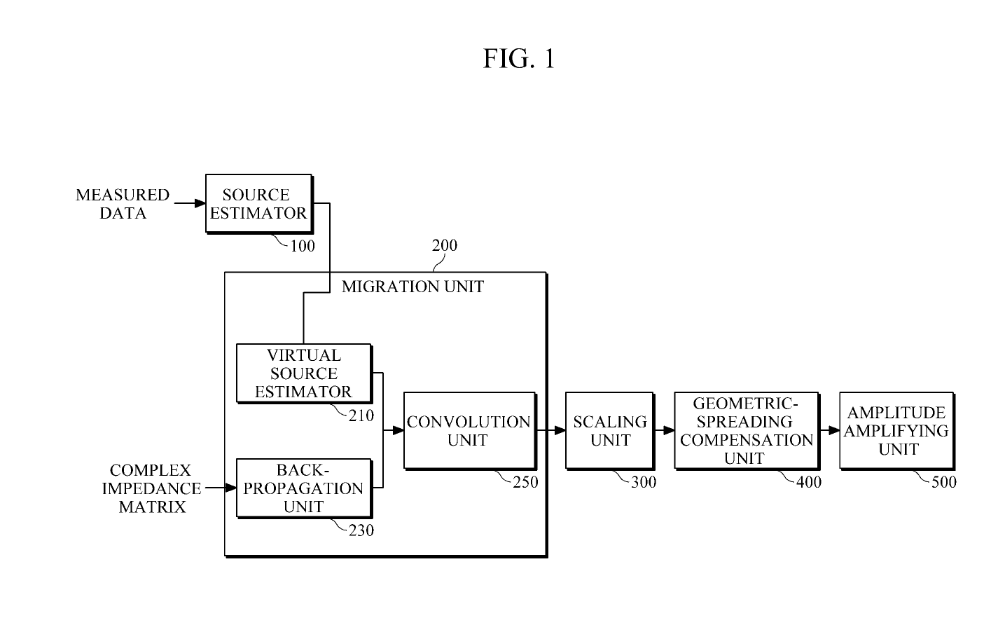

FIG. 1 is a diagram illustrating an example of a reverse-time migration apparatus. As illustrated in FIG. 1, the reverse-time migration apparatus includes a source estimator 100 that estimates sources from measured data on receivers, and a migration unit 200 that receives information about the estimated sources to perform reverse-time migration in the frequency domain.

According to an example, the migration unit 200 includes a back-propagation unit 230 that back-propagates the measured data on the receivers, a virtual source estimator 210 that estimates virtual sources from the sources estimated by the source estimator 100, and a convolution unit 250 that convolves the back-propagated data with the virtual sources and outputs the convolved data.

As mentioned in the paper “Evaluation of Poststack Migration in Terms of Virtual Source and Partial Derivative Wavefields: Journal of Seismic Exploration, 12, 17-37” (Shin, C., D.-J. Min, D. Yang and S.-K.Lee, 2003), migration can generally be expressed as a zero-lag cross-correlation between the partial derivative wavefields with respect to an earth parameter (such as velocity, density or impedance) and the measured data on the receivers in the time domain, as follows.

$${φ}_{k} = {\sum }_{s = 1}^{nshot} {\int }_{0}^{{T}_{max}} {[ \frac{\partial {u}_{s} ( t )}{\partial {m}_{k}} ]}^{T} {d}_{s} ( t ) d t , \qquad ( 1 )$$

where Φₖ denotes the 2D migration image for the k-th model parameter, Tₘₐₓ is the maximum record length,

$$\frac{\partial {u}_{s} ( t )}{\partial {m}_{k}}$$

is the partial derivative wavefield vector, dₛ(t)is the field data vector, and s indicates the shot number.

In the frequency domain, migration can be expressed using the Fourier transform pairs (Brigham, E. O., 1988, the Fast Fourier Transform and its Applications: Avantek, Inc., Prentice Hall.) as:

$${φ}_{k} = {\sum }_{s = 1}^{nshot} {\int }_{0}^{{ω}_{max}} Re \{ {[ \frac{\partial {\tilde{u}}_{s} ( ω )}{\partial {m}_{k}} ]}^{T} {\tilde{d}}_{s}^{*} ( ω ) \} d ω , \qquad ( 2 )$$

where ω is the angular frequency, ũₛ and \tilde{d}ₛ are the frequency-domain modeled and field data vectors, the superscript * denotes the complex conjugate, and Re indicates the real part of a complex value.

In waveform inversion, an objective function can be written as:

$$E = \frac{1}{2} {\sum }_{s = 1}^{nshot} {\int }_{0}^{{ω}_{max}} {{[ {\tilde{u}}_{s} ( ω ) - {\tilde{d}}_{s} ( ω ) ]}^{T} [ {\tilde{u}}_{s} ( ω ) - {\tilde{d}}_{s} ( ω ) ]}^{*} d ω , \qquad ( 3 )$$

where the superscript T represents the transpose of the vector and (ũₛ-\tilde{d}ₛ) is the residual vector between modeled and field data. The gradient is obtained by taking the partial derivative of the objective function with respect to the model parameter, which yields:

$$\frac{\partial E}{\partial {m}_{k}} = {\sum }_{s = 1}^{nshot} {\int }_{0}^{{ω}_{max}} Re \{ {( \frac{\partial {\tilde{u}}_{s}}{\partial {m}_{k}} )}^{T} {( {\tilde{u}}_{s} - {\tilde{d}}_{s} )}^{*} \} d ω , \qquad ( 4 )$$

It is seen that equation 2 has the same form as equation 4, which means that the reverse-time migration corresponds to the gradient in waveform inversion.

To obtain the migration image or gradient, the partial derivative wavefields in equation 2 have to be computed, which can be obtained by using a forward-modeling algorithm (Shin, C., S. Pyun, and J. B. Bednar, 2007, Comparison of Waveform Inversion, Part 1: Conventional Waveform vs. Logarithmic Wavefield: Geophys. Prosp., 55, 449-464). Frequency-domain wave modeling can be expressed in matrix form (Marfurt, K. J., 1984, Accuracy of Finite-difference and Finite-element Modeling of the Scalar and Elastic Wave Equation: Geophysics, 49, 533-549) as:

Sũₛ=f _{and} (5)

S=K+iωC+ω²M, (6)

where f is the source vector, S is the complex impedance matrix originating from the finite-element or finite-difference methods, and K , C , and M are the stiffness, damping, and mass matrices, respectively. When the derivative of equation 5 with respect to the model parameter m, is taken, the partial derivative wavefields (Pratt, R. G., C. Shin, and G. J. Hicks, 1998, Gauss-Newton and Full Newton Methods in Frequency Domain Seismic Waveform Inversions: Geophys. J. Int., 133, 341-362) can be obtained as follows:

$$\begin{matrix}S \frac{\partial {\tilde{u}}_{s}}{\partial {m}_{k}} + \frac{\partial S}{\partial {m}_{k}} {\tilde{u}}_{s} = 0 and & ( 7 ) \\ \frac{\partial {\tilde{u}}_{s}}{\partial {m}_{k}} = {S}^{- 1} {f}_{v} , & ( 8 )\end{matrix}$$

where fᵥ is the virtual source vector expressed by

$${f}_{v} = - \frac{\partial S}{\partial {m}_{k}} {\tilde{u}}_{s} .$$

Substituting equation 8 into equation 2 gives

$${φ}_{k} = {\sum }_{s = 1}^{nshot} {\int }_{0}^{{ω}_{max}} Re [ {{f}_{v}^{T} ( {S}^{T} )}^{- 1} {d}_{s}^{*} ] d ω \qquad ( 9 )$$

for the k-th model parameter. If all of the model parameters are considered, the virtual source vector is replaced with the virtual source matrix Fᵥ^{T}:

$$φ = {\sum }_{s = 1}^{nshot} {\int }_{0}^{{ω}_{max}} Re [ {{F}_{v}^{T} ( {S}^{T} )}^{- 1} {d}_{s}^{*} ] d ω . \qquad ( 10 )$$

In equation 10, the combination (S^{T})⁻¹dₛ^{*} of the second and third terms means the back-propagation of field data, because the complex impedance matrix S is symmetrical. By convolving the back-propagated field data with virtual sources, a reverse-time migration image may be obtained.

As illustrated in FIG. 1, the migration unit 200 obtains the reverse-time migration image by using the back-propagation unit 230 that back-propagates the measured data on the receivers, the virtual source estimator 210 that estimates virtual sources from the sources estimated by the source estimator 100, and the convolution unit 250 that convolves the back-propagated data with the virtual sources and outputs the convolved data. Back-propagation has been well-known in the seismic exploration technology.

The virtual source estimator 210 computes the virtual sources from forward-modeled data, for which a source wavelet has to be obtained. In general cases, the source wavelet has been assumed to be either a near-offset trace or a well-known function, such as a Ricker wavelet, or the first derivative of a Gauss function, because the exact source wavelet cannot be reproduced in either field exploration or seismic data processing. According to an example, if the source wavelet is estimated as in the waveform inversion algorithm, more reliable source wavelets can be employed in reverse-time migration, which may yield better images.

The convolution unit 250 multiplies the back-propagated data matrix by the virtual source matrix, which means convolution in the time domain.

According to an example, the source estimator 100 estimates the source wavelet by an optimization method such as the least-squares methods in the frequency domain. The time-domain source wavelet can be obtained by taking the inverse Fourier transform of the source wavelet estimated in the frequency domain. According to an example, the source estimator 100 applies the full Newton method on the initial source vector for source wavelet estimation. The full Newton method is disclosed in detail in the paper “A Review of Least-squares Inversion and its Application to Geophysical Problems: Geophys. Prosp., 32, 159-186” (Lines, L. R., S. Treitel, 1984).

If it is assumed that the numerical green function is cⱼ+idⱼ at the j-th receiver and the true source wavelet is e+if at a single frequency, the modeled data at the j-th receiver can be expressed as (cⱼ+idⱼ) (e+if) . Supposing that the observed seismogram at the j-th receiver is expressed by aⱼ+ibⱼ, as disclosed in the paper “Comparison of waveform inversion, part 1: Conventional wavefield vs. logarithmic wavefield: Geophys. Prosp., 55, 449-464” (Shin, C., S. Pyun, and J. B. Bednar, 2007), an objective function for the source wavelet can be expressed using L2-norm, as follows:

$$\begin{matrix}E = \frac{1}{2} {\sum }_{j} δ {r}_{j} δ {r}_{j}^{*} \\ = \frac{1}{2} {\sum }_{j} \{ {( {c}_{j} e - {d}_{j} f - {a}_{j} )}^{2} + {( {c}_{j} f + {d}_{j} e - {b}_{j} )}^{2} \} ,\end{matrix} \qquad ( 11 )$$

where δrⱼ indicates the residual between the wavefield for the initial model and the observed wavefield at the j-th receiver.

Meanwhile, as disclosed in “A Review of Least-squares Inversion and its Application to Geophysical Problems: Geophys. Prosp., 32, 159-186” (Lines, L. R., and S. Treitel, 1984), in the full Newton method, an incremental change of a source wavelet is given as:

δp_{src}=−H⁻¹∇E,

where ∇E is the gradient vector of the object function with respect to the source wavelet, and H is the Hessian matrix.

Accordingly, the source wavelet can be modified from an initial source wavelet using:

$$\begin{matrix}{p}_{src}^{( n + 1 )} = {p}_{src}^{( n )} + δ {p}_{src} \\ = {p}_{src}^{( n )} - {H}^{- 1} ∇ E\end{matrix} \qquad ( 12 )$$

The Hessian matrix is given as follows:

$$H = ( \begin{matrix}\frac{{\partial }^{2} E}{\partial {e}^{2}} & \frac{{\partial }^{2} E}{\partial e \partial f} \\ \frac{{\partial }^{2} E}{\partial f \partial e} & \frac{{\partial }^{2} E}{\partial {f}^{2}}\end{matrix} ) \qquad ( 13 )$$

Substituting equation 13 into equation 12 yields:

$$δ {p}_{src} = ( \begin{matrix}δ e \\ δ f\end{matrix} ) = {( \begin{matrix}\frac{{\partial }^{2} E}{\partial {e}^{2}} & \frac{{\partial }^{2} E}{\partial e \partial f} \\ \frac{{\partial }^{2} E}{\partial f \partial e} & \frac{{\partial }^{2} E}{\partial {f}^{2}}\end{matrix} )}^{- 1} ( \begin{matrix}\frac{\partial E}{\partial e} \\ \frac{\partial E}{\partial f}\end{matrix} ) \qquad ( 14 )$$

In equation 14, δe and δf are the incremental changes in the real and imaginary components of the source wavelet. The seismic source wavelet can be estimated by updating the initial source wavelet by δe and δf.

According to another example, the frequency-domain reverse-time migration apparatus further includes a scaling unit 300 that scales the migrated image using the diagonal of the pseudo-Hessian matrix. As disclosed in the paper “Improved Amplitude Preservation for Prestack Depth Migration by Inverse Scattering Theory: Geophys. Prosp., 49, 592-606” (Shin, C., S. Jang and D.-J. Min, 2001), a reverse-time migration image can be enhanced by scaling the migrated image using the diagonal of the pseudo-Hessian matrix. By applying the scaling method to equation 10, the migration image can be rewritten as:

$$φ = NRM ( {\int }_{0}^{{ω}_{max}} NRM ( \frac{Re [ {{F}_{v}^{T} ( {S}^{T} )}^{- 1} {d}_{s}^{*} ]}{Re [ diag ( {( {F}_{v} )}^{* T} {F}_{v} ) ] + λ} ) d ω ) , \qquad ( 15 )$$

where diag[(Fᵥ)^{*T} Fᵥ] indicates the diagonal of the pseudo-Hessian matrix, λ is the damping factor, and the symbol NRM denotes normalization. The normalization was disclosed in the paper “Waveform inversion using a back-propagation algorithm and a Huber function: Geophysics, 74(3), R15-R24” (Ha, T., W.-K. Chung and C. Shin, 2009).

Compared to the approximate Hessian matrix, the impulse response terms that describe geometric spreading effects are missing in the pseudo-Hessian matrix. For this reason, the pseudo-Hessian matrix may have some limitations in depicting geometric spreading effects in some models (see the paper “Frequency-domain Elastic Full Waveform Using the New Pseudo-Hessian Matrix: Experience of Elastic Marmousi-2 Synthetic Data: Bull. Seism. Soc. Am., 98, 2402-3415” (Choi, Y., D.-J. Min and C. Shin, 2008)).

These limitations can be overcome either by incorporating impulse responses (Green's functions) to the pseudo-Hessian matrix, as done by Choi et al. (2008), or by applying a depth-variant scaling function to the images normalized by the pseudo-Hessian matrix. According to another example, the frequency-domain reverse-time migration apparatus further includes a geometric-spreading compensator 400 that multiplies an image normalized by the pseudo-Hessian matrix by a depth-variant scaling function whose value changes according to a depth. The depth-variant scaling function is a kind of AGC (automatic gain control) determined by the experiment. By using the depth-variant scaling function, the migrated image can be expressed as:

$$φ = NRM ( {\int }_{0}^{{ω}_{max}} NRM ( \frac{Re [ {{F}_{v}^{T} ( {S}^{T} )}^{- 1} {d}_{s}^{*} ]}{Re [ diag ( {( {F}_{v} )}^{* T} {F}_{v} ) ] + λ} * {depth}^{2.5} ) d ω ) \qquad ( 16 )$$

In order to obtain high-resolution images, according to another example, the frequency-domain reverse-time migration apparatus further includes an amplitude amplifier 500 that multiplies the migrated image by the amplitude spectrum of the source wavelet, which plays a role in weighting some frequency components of the migration images, especially around the dominant frequency of the source wavelet.

$$φ = NRM ( {\int }_{0}^{{ω}_{max}} NRM ( \frac{Re [ {{F}_{v}^{T} ( {S}^{T} )}^{- 1} {d}_{s}^{*} ]}{Re [ diag ( {( {F}_{v} )}^{* T} {F}_{v} ) ] + λ} \cdot {depth}^{2.5} \cdot \vert {g}_{estimated} ( ω ) \vert ) d ω ) \qquad ( 17 )$$

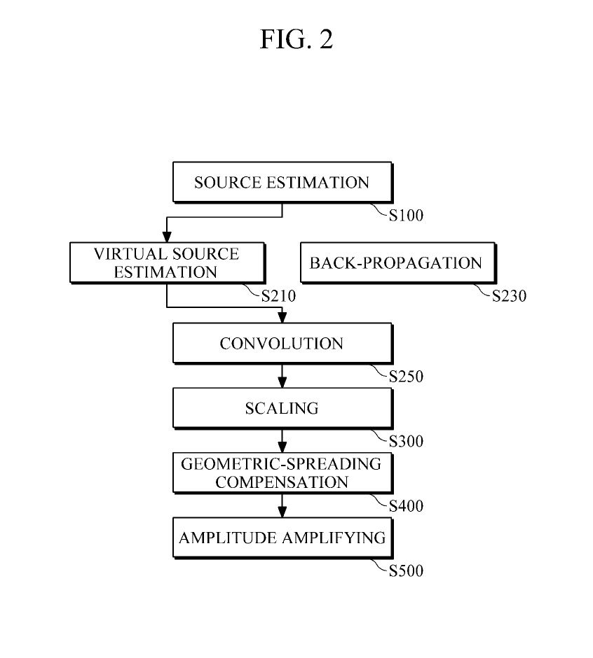

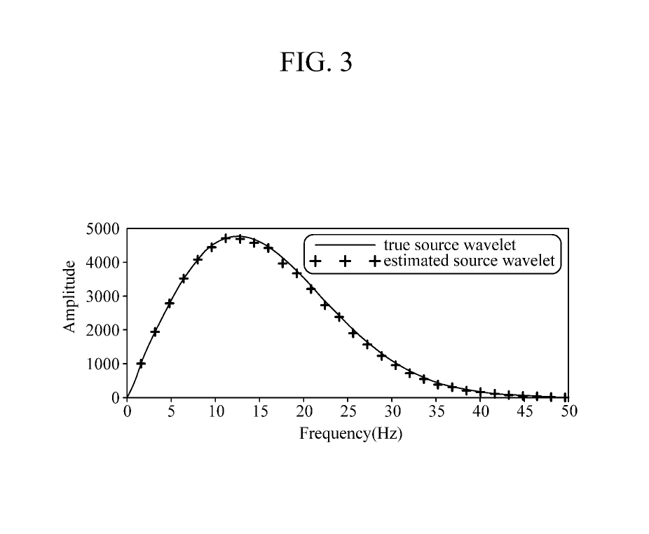

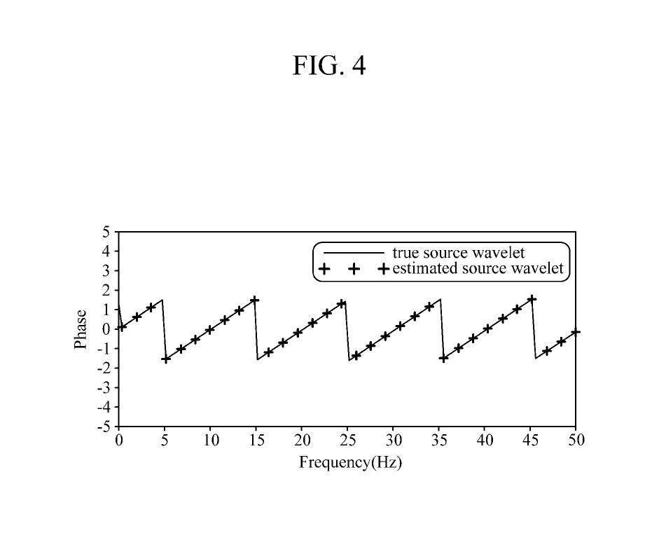

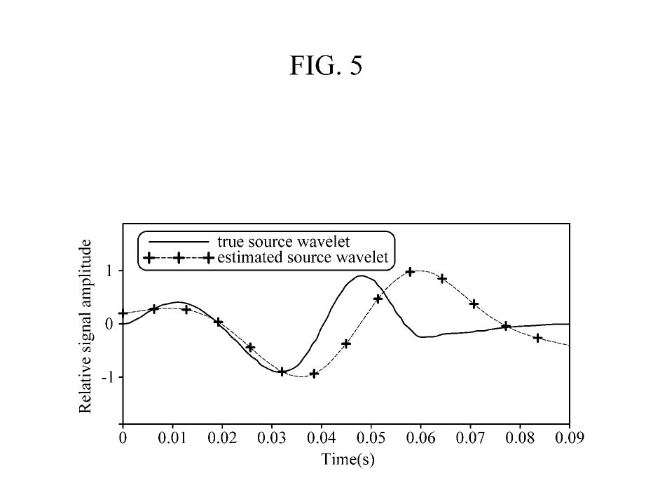

FIG. 2 is a flowchart illustrating an example of a reverse-time migration method. As illustrated in FIG. 2, the reverse-time migration method includes source estimation operation (S100) of estimating sources from measured data on receivers; and migration operation (S210, S230, S250) of receiving information about the estimated sources and performing reverse-time migration in the frequency domain.

According to an example, in the source estimation operation (S100), the sources are estimated by the least-squares method in the frequency domain. In more detail, the sources are estimated by updating the initial source vector using incremental changes according to the full Newton method. The incremental changes according to the full Newton method were defined in the above equation 14.

According to an example, the migration operation includes back-propagation operation (S230) of back-propagating the measured data, virtual source estimation operation (S210) of estimating virtual sources from the sources estimated in the source estimation operation (S100), and convolution operation (S250) of convolving the back-propagated data with the virtual sources and outputting the results of the convolution. The back-propagation operation (S230) is to apply the back-propagation method on (S^{T})⁻¹dₛ^{*} of equation 17.

The virtual source estimation operation (S210) is expressed by equation 9, to calculate a matrix Fᵥ of equation 10 by iterating a virtual source defined by

$${f}_{v} = - \frac{\partial S}{\partial {m}_{k}} {\tilde{u}}_{s}$$

with respect to all model parameters. In order to obtain the virtual sources, forward-modeled data is required and an estimated source wavelet is required for obtaining the forward-modeled data. The convolution operation (S250) is to multiply the results obtained by equation 17 in the back-propagation operation (S230) by the matrix Fᵥ^{T} , that is, to convolve the results obtained in the back-propagation operation (S230) in the time domain.

According to an example, the reverse-time migration method further includes scaling operation (S300) of scaling the migrated image obtained in the migration operation (S210, S230, S250) using the diagonal of the pseudo-Hessian matrix. The scaling operation (S300) is to divide the real part of the result obtained in the migration operation (S210, S230, S250) by the real part of the diag [(Fᵥ)^{*T} Fᵥ] term and normalize the result of the division.

According to another example, the reverse-time migration method may further include geometric-spreading compensation operation (S400) of multiplying the image scaled by the pseudo-Hessian matrix in the scaling operation (S300) by the depth-variant scaling function whose value changes according to a depth. The geometric-spreading compensation operation (S400) is a procedure of multiplying the term depth^{2.5} in equation 17. The geometric-spreading compensation operation (S400) is a selective procedure that can be applied to specific data such as a BP model.

According to another example, the reverse-time migration method further includes amplitude amplifying operation (S500) of multiplying the migrated image for each frequency obtained in the migration operation (S210, S230, S250) by the amplitude spectrum of the source estimated in the source estimation operation (S100). The amplitude amplifying operation (S500) is a procedure of multiplying |g_{estimated}(w)| in equation 17.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A frequency-domain reverse-time migration apparatus comprising:
a source estimator configured to estimate sources from data measured on a plurality of receivers; and
a migration unit configured to receive information about the sources estimated by the source estimator and to perform reverse-time migration in the frequency domain.

2. The frequency-domain reverse-time migration apparatus of claim 1, wherein the source estimator estimates the sources using a least-squares method in the frequency domain.

3. The frequency-domain reverse-time migration apparatus of claim 2, wherein the source estimator estimates the sources by updating an initial source vector using incremental changes according to a full Newton method.

4. The frequency-domain reverse-time migration apparatus of claim 1, wherein the migration unit comprises:
a back-propagation unit configured to back-propagate the measured data;
a virtual source estimator configured to estimate virtual sources from the sources estimated by the source estimator; and
a convolution unit configured to convolve the back-propagated measured data with the virtual sources and to output the results of the convolution.

5. The frequency-domain reverse-time migration apparatus of claim 4, further comprising:
a scaling unit configured to scale the migrated image output from the migration unit using diagonal terms of a pseudo-Hessian matrix.

6. The frequency-domain reverse-time migration apparatus of claim 5, further comprising:
a geometric-spreading compensation unit configured to multiply the image scaled by the scaling unit by a depth-variant scaling function.

7. The frequency-domain reverse-time migration apparatus of claim 4, further comprising an amplitude amplifying unit configured to multiply a migrated image for each frequency output from the migration unit by an amplitude spectrum of a source estimated by the source estimator.

8. A frequency-domain reverse-time migration method comprising:
estimating sources from data measured on a plurality of receivers; and
receiving information about the estimated sources and performing reverse-time migration in the frequency domain.

9. The frequency-domain reverse-time migration method of claim 8, wherein the estimating of the sources comprises estimating the sources using a least-squares method in the frequency domain.

10. The frequency-domain reverse-time migration method of claim 9, wherein the estimating of the sources comprises estimating the sources by updating an initial source vector using incremental changes according to a full Newton method.

11. The frequency-domain reverse-time migration method of claim 8, wherein the performing of the reverse-time migration in the frequency domain comprises:
back-propagating the measured data;
estimating virtual sources from the estimated sources; and
convolving the back-propagated data with the virtual sources and outputting the results of the convolution.

12. The frequency-domain reverse-time migration method of claim 11, further comprising scaling the image migrated in the performing of the reverse-time migration using a diagonal term of a pseudo-Hessian matrix.

13. The frequency-domain reverse-time migration method of claim 12, further comprising multiplying the image scaled by the pseudo-Hessian matrix by a depth-variant scaling function.

14. The frequency-domain reverse-time migration method of claim 11, further comprising multiplying a migrated image for each frequency, obtained from performing the reverse-time migration, by an amplitude spectrum of the estimated source.
